(19) United States
(12) Patent Application Publication
(10) Pub. No.: US 2007/0016892 A1
(43) Pub. Date: Jan. 18, 2007

(54) METHOD AND SYSTEM FOR DEVELOPING AN EXPANDABLE LANGUAGE INSTALL PACK

(76) Inventor: Bingbing Cao, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/163,392

(22) Filed: Oct. 17, 2005

(30) Foreign Application Priority Data
Jul. 12, 2005 (TW) 094123562

(51) Int. Cl. G06F 9/44

(52) U.S. Cl. 717/127

(57) ABSTRACT

A method for developing an expandable language install pack is disclosed. The method includes: providing an install pack developer; setting a display interface corresponding to an intermediate install pack; assigning a string identity code to a first string which will be displayed on the display interface; recording the string identity code and the first string in a mapping table; generating the intermediate install pack utilizing the install pack developer, wherein the install pack developer does not utilize the mapping table to generate the intermediate install pack; and generating the expandable language install pack utilizing the install pack developer according to the intermediate install pack and the mapping table.

### BACKGROUND OF THE INVENTION

1. Field of the Invention

The present invention relates to a method and a system for developing an install pack, and more specifically, to a method and a system for developing an expandable language install pack according to a mapping table, wherein the mapping table stores strings that may be displayed.

2. Description of the Prior Art

A programmer generally utilizes an install pack developer to develop an install pack. For example, the install pack developer can be the InstallShield Developer provided by the InstallShield Software Corporation. In this way, the programmer can create a new project in the program development environment provided by the InstallShield Developer and develop the install pack.

However, in consideration of the current international market, an install pack must be capable of displaying multi-language strings on a display interface provided during the execution of the install pack. Hence, according to the prior art, the programmer usually needs to further purchase a multi-language pack and then install it for utilization. For example, the multi-language pack can be an InstallShield Multi-language Pack. The InstallShield Multi-language Pack is an extension packager of the InstallShield Developer. Afterwards, during the compilation process of the above-mentioned project, by using the multi-language pack, a multi-language install pack can provide the addition of a desired natural language that will be supported according to appropriate settings. In this way, a multi-language install pack can be generated. After the above-mentioned project has been compiled, the display interface provided during the execution of the generated multi-language install pack can support displaying strings of a plurality of natural languages. In other words, when a user executes the prior art multi-language install pack, the prior art multi-language install pack can display appropriate strings according to a natural language selected or utilized by the user.

However, the above-mentioned multi-language install pack has the following disadvantages:

1. Language limitation: The natural languages supported by the multi-language install pack are limited to those natural languages provided by the multi-language pack (i.e. the InstallShield multi-language pack). The programmer cannot add other natural languages to the multi-language install pack. That means the display interface of the multi-language install pack cannot display a string of a natural language that the multi-language pack does not support. For example, if the multi-language pack does not support Arabic, the display interface of the multi-language install pack cannot display an Arabic string.

2. Large-sized pack: The programmer utilizes the multi-language pack to develop the desired multi-language install pack. However, the multi-language install pack includes a large amount of unnecessary data, such as some strings that will not be displayed. Therefore, the file size of the multi-language install pack is significantly greater than the file size of the install pack generated by the install pack developer, wherein the install pack generated by the install pack developer cannot support multi-languages.

3. The cost effective: The multi-language pack is an extension packager of the install pack developer. The multi-language pack is usually a very expensive extension packager. The price of the multi-language pack is even more than the price of the install pack developer itself. Hence, the cost of developing the multi-language install pack is significantly increased because of the utilization of the multi-language pack.

### SUMMARY OF THE INVENTION

One of the objectives of the claimed invention is therefore to provide a system and a method for developing an expandable language install pack according to a mapping table, wherein the mapping table stores strings that may be displayed, to solve the aforementioned problem.

According to the claimed invention, a method for developing an expandable language install pack is disclosed. The method comprises: providing an install pack developer; setting a display interface corresponding to an intermediate install pack; assigning a string identity code to a first string which will be displayed on the display interface; recording the string identity code and the first string in a mapping table; generating the intermediate install pack utilizing the install pack developer, wherein the install pack developer does not utilize the mapping table to generate the intermediate install pack; and generating the expandable language install pack utilizing the install pack developer according to the intermediate install pack and the mapping table.

In addition, the claimed invention provides a system for developing an expandable language install pack. The system comprises a mapping table and an install pack developer. The mapping table comprises a first string, and a string identity code corresponding to the first string. The install pack developer is utilized for generating an intermediate install pack without utilizing the mapping table, and utilizing the mapping table and the intermediate install pack to generate the expandable language install pack. The intermediate install pack corresponds to a display interface comprising the first string.

During the development and the execution of a expandable language install pack, in order to make the display interface of the expandable language install pack capable of displaying strings of a plurality of natural languages, the method according to the claimed invention comprises further building a mapping table. The mapping table is an external file with respect to the install pack developer and the expandable language install pack. The expandable language install pack according to the claimed invention comprises the following advantages:

1. The expandable language install pack according to the claimed invention is capable of expanding its own language capabilities. This means that it can support more natural languages and display more strings. According to the claimed invention, all possible strings of a plurality of natural languages which may be displayed on the display interface of the expandable language install pack are recorded in a mapping table made by a programmer. Therefore, the programmer can easily add or delete natural languages supported by the expandable language install pack, and can easily add/delete/modify strings of the natural languages.

2. The mapping table contains only the strings that may be displayed on the display interface of the expandable language install pack. It does not contain useless data (i.e., strings that will not be displayed). Therefore, the file size of the mapping table is very small. Compared with the prior art expandable language install pack, the file size of the expandable language install pack according to the claimed invention can be significantly reduced. 3. The expandable language install pack according to the claimed invention does not require an expensive multi-language pack (i.e., an InstallShield multi-language pack utilized by the prior art). Hence, the cost of developing the expandable language install pack can be significantly reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an expandable language install pack of the present invention.

FIG. 2 is a diagram of a Traditional Chinese display interface, as it appears when the intermediate install pack shown in FIG. 1 is being executed.

FIG. 3 is a diagram of an English display interface, as it appears when the intermediate install pack shown in FIG. 1 is being executed.

FIG. 4 is a diagram of the mapping table shown in FIG. 1.

### DETAILED DESCRIPTION

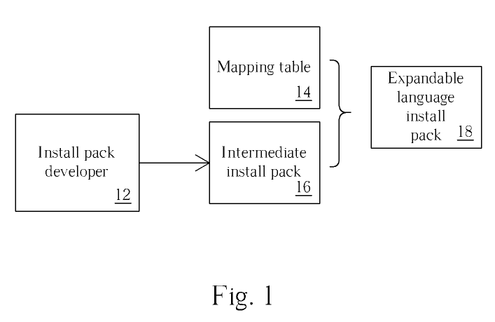

Please refer to FIG. 1. FIG. 1 is a diagram illustrating an expandable language install pack of the present invention and an installer packager developer 12, a mapping table 14, an intermediate installer packager 16, and an expandable language install pack 18 are shown in FIG. 1. The install pack developer 12 is utilized for generating the intermediate install pack 16 corresponding to an application program, and compressing the generated intermediate install pack 16 and the mapping table 14 into the expandable language install pack 18. That is, the expandable language install pack 18 is a compressed file which comprises the intermediate install pack 16 and the mapping table 14. When a user is executing the expandable language install pack 18 in order to use the application program; in fact, the user is executing the intermediate install pack, and the mapping table 14 records string data required when the intermediate install pack 16 is being executed. The descriptions of the intermediate install pack 16, the expandable language install pack 18 and the mapping table 14 are included in the following paragraphs.

After the user executes the intermediate install pack 16, the desired application program has been installed in a computer system. In the present embodiment, as is well known in the art, when a programmer executes the install pack developer 12 to develop the intermediate install pack 16, the install pack developer 12 provides a certain degree of freedom so that the programmer processes the control to the presentation of the display interface provided by the intermediate install pack 16 when the intermediate install pack 16 is being executed, including the display of the strings. Please note that the install pack developer 12 can be the InstallShield Developer provided by the InstallShield Software Corporation. The InstallShield Developer is capable of providing a programmer with the above-mentioned control to the presentation of the display interface provided by the intermediate install pack 16 when the intermediate install pack 16 is being executed. In addition, the main difference between the present invention and the prior art is about the display of the strings that will be displayed on the display interface of the intermediate install pack 16, and the related detailed description is included in the following paragraph. The detailed description of the generating process and the operation of executing the intermediate install pack 16 are similar to those according to the prior art and therefore is omitted for the sake of brevity.

In the present embodiment, for the convenience of description, assume that two natural languages, Traditional Chinese and English, can be displayed on the display interface of the intermediate install pack 16. However, it should be noted that the natural languages that can be displayed in the present invention are not limited to Traditional Chinese and English in the present embodiment.

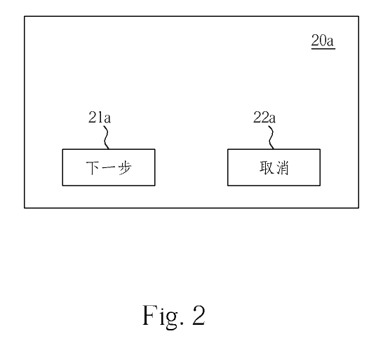

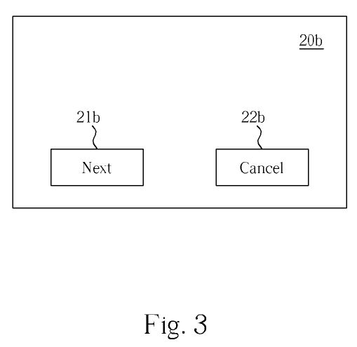

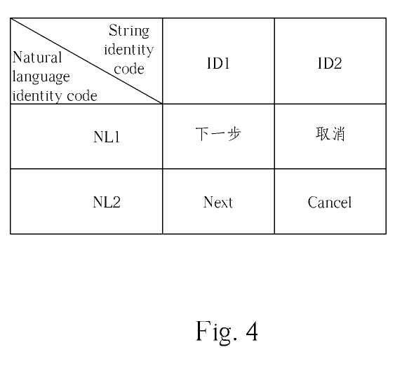

Please refer to FIG. 1, FIG. 2 and FIG. 3. FIG. 2 is a diagram of a Traditional Chinese display interface 20a, as it appears when the intermediate install pack 16 shown in FIG. 1 is being executed. In FIG. 2, two Traditional Chinese strings [symbol] and [symbol] are respectively shown on two buttons 21a and 22a for the user to control the execution process of the intermediate install pack 16. FIG. 3 is a diagram of an English display interface 20b shown when the intermediate install pack 16 shown in FIG. 1 is being executed. In FIG. 3, two English strings “Next” and “Cancel” are respectively shown on two buttons 21b and 22b. The programmer uses the install pack developer 12 to develop the intermediate install pack 16 and designs the intermediate install pack 16 to support the two natural languages, in this example: Traditional Chinese and English. Therefore, during the execution of the intermediate install pack 16, the strings [symbol] (as shown in FIG. 2) or the strings “Next”, “Cancel” (as shown in FIG. 3) must be displayed on the display interface. The programmer respectively assigns natural language identity codes NL1 and NL2 to the natural languages, Traditional Chinese and English. That means the natural language identity codes NL1 and NL2 respectively represent the natural languages, Traditional Chinese and English. The programmer also assigns a string identity code ID1 to the strings [symbol] and “Next”, and assigns a string identity code ID2 to the strings [symbol] and “Cancel”. The above-mentioned steps allow the programmer to take control of the display interface from the install pack developer 12, which means the programmer actively controls the settings of the display interface and does not passively set the display interface using the options provided by the install pack developer 12. In the present embodiment, the programmer further records the aforementioned natural language identity codes NL1 and NL2, the string identity codes ID1 and ID2, and the strings [symbol] “Next” and “Cancel” in the mapping table 14, as shown in FIG. 4. FIG. 4 is a diagram of the mapping table 14 shown in FIG. 1.

The description of the intermediate install pack 16 retrieving a required string using the mapping table 14 is described here. When the programmer develops the intermediate install pack 16, the programmer sets a path in the intermediate install pack 16, wherein the path corresponds to the mapping table 14. Next, during the execution of the intermediate install pack 16, if the intermediate install pack 16 needs to display a natural language string, the intermediate install pack 16 first finds the mapping table 14 according to the path, and then reads the required string from the mapping table 14. For example, if the Traditional Chinese string [symbol] is going to be displayed on the Traditional Chinese display interface 20a, the intermediate install pack 16 must look up the mapping table 14 according to the natural language identity code NL1 and the string identity code ID1 for the Traditional Chinese string [symbol] and then reads the Traditional Chinese string [symbol] from the mapping table 14. On the other hand, if the English string “Next” is going to be displayed on the English display interface 20b, the intermediate install pack 16 must look up the mapping table 14 according to the natural language identity code NL2 and the string identity code ID1 for the English string “Next”, and then reads the English string “Next” from the mapping table 14. Finally, the install pack developer 12 compresses the generated intermediate install pack 16 and the mapping table 14 into an expandable language install pack 18.

It should be noted that for the install pack developer 12, the mapping table 14 is an external file (not an internal file), which means that the mapping table 14 is not integrated into the install pack developer 12, nor is it an extension tool of the install pack developer 12. During the process of the install pack developer 12 developing the intermediate install pack 16, it does not need the mapping table 14. However, according to the prior art, during the process of an install pack developer generating a expandable language install pack, the install pack developer must utilize its own extension packager (i.e., a multi-language pack; for example, an InstallShield multi-language pack) for generating the expandable language install pack.

When the user's computer system executes the expandable language install pack 18, the expandable language install pack 18 is uncompressed and then the mapping table 14 and the intermediate install pack 16 will be uncompressed and then stored in a subdirectory of the computer system. Next, the computer system starts executing the intermediate install pack 16; meanwhile, a display interface shows that the user can select a natural language from the two natural languages, Traditional Chinese and English. If the user selects Traditional Chinese, all the strings afterwards displayed on the display interface will be Traditional Chinese strings; if the user selects English, all the strings afterwards displayed on the display interface will be English strings.

Assume for this example that the user selects Traditional Chinese (the natural language identity code of Traditional Chinese is NL1). The monitor of the computer system will display the Traditional Chinese display interface 20a. When the Traditional Chinese string is going to be shown on the button 21a of the Traditional Chinese display interface 20a, the intermediate install pack 16 looks up the mapping table 14 in the subdirectory according to the natural language identity code NL1 and the string identity code ID1 for the Traditional Chinese string [symbol] and then displays the Traditional Chinese string [symbol] on the button 21a. In the same manner, when the Traditional Chinese string is going to be shown on the button 22a, the intermediate install pack 16 looks up the mapping table 14 according to the natural language identity code NL1 and the string identity code ID2 for the Traditional Chinese string [symbol] and then displays the Traditional Chinese string [symbol] on the button 22a. Similarly, if the user selects English (the natural language identity code of English is NL2), the monitor of the computer system displays the English display interface 20b of the intermediate install pack 16. When the English string is going to be shown on the button 21b of the English display interface 20b, the intermediate install pack 16 looks up the mapping table 14 in the subdirectory according to the natural language identity code NL2 and the string identity code ID1 for the English string “Next”, and then displays the English string “Next” on the button 21b. In the same manner, when the English string is going to be shown on the button 22b, the intermediate install pack 16 looks up the mapping table 14 according to the natural language identity code NL2 and the string identity code ID2 for the English string “Cancel”, and then displays the English string “Cancel” on the button 22b. Please note that in the present embodiment, the path utilized by the intermediate install pack 16 for accessing the mapping table 14 is appropriately set according to the subdirectory utilized when the expandable language install pack 18 is being uncompressed. However, if the mapping table 14 and the intermediate install pack 16 are respectively uncompressed and stored into different subdirectories, the path utilized by the intermediate install pack 16 for accessing the mapping table 14 will be set according to the actual subdirectory corresponding to the mapping table 14.

In contrast to the prior art, during the development and execution of a expandable language install pack, in order to make the display interface of the expandable language install pack capable of supporting strings of a plurality of natural languages, the method of the present invention further comprises building a mapping table. The mapping table is an external file with respect to the install pack developer and the expandable language install pack. The prior art utilizes the install pack developer's own extension packager, such as the multi-language pack (e.g., the Installshield multi-language pack provided by the Installshield Software Corporation), to provide the required capabilities of supporting multi-languages. The development of the expandable language install pack according to the present invention provides the following advantages:

1. The expandable language install pack according to the present invention is capable of expanding its own language capabilities. This means that it can support more natural languages and display more strings. According to the present invention, all possible strings of a plurality of natural languages which may be displayed on the display interface of the expandable language install pack are recorded in a mapping table made by a programmer. Therefore, the programmer can easily add or delete natural languages supported by the expandable language install pack, and can easily add/delete/modify strings of the natural languages. For example, if Arabic strings are going to be displayed, the programmer just needs to assign a natural language identity code (e.g.: NL3) to the natural language Arabic, and assigns string identity codes ID1˜Idn to Arabic strings to be displayed. Please refer to the above-mentioned method for the remaining steps. In this way, the Arabic strings can be displayed on the display interface of the expandable language install pack.

2. The mapping table contains only strings that may be displayed on the display interface of the expandable language install pack. It does not contain useless data (i.e., strings that will not be displayed). Therefore, the file size of the mapping table is very small. Compared with the prior art expandable language install pack, the file size of the expandable language install pack according to the present invention can be significantly reduced.

3. The expandable language install pack according to the present invention does not require an expensive multi-language pack (i.e., an InstallShield multi-language pack utilized by the prior art). Hence, the cost of developing the expandable language install pack can be significantly reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for developing an expandable language install pack, comprising:
providing an install pack developer;
setting a display interface corresponding to an intermediate install pack;
assigning a string identity code to a first string which will be displayed on the display interface;
recording the string identity code and the first string in a mapping table;
generating the intermediate install pack utilizing the install pack developer, wherein the install pack developer does not utilize the mapping table to generate the intermediate install pack; and
generating the expandable language install pack utilizing the install pack developer according to the intermediate install pack and the mapping table.

2. The method of claim 1, wherein the mapping table is an external file with respect to the install pack developer.

3. The method of claim 1, wherein the mapping table is an external file with respect to the intermediate install pack.

4. The method of claim 1, further comprising:
assigning a first natural language identity code to a first natural language which the first string belongs to; and
recording the first natural language identity code in the mapping table.

5. The method of claim 4, further comprising:
further assigning the string identity code to a second string which will be displayed on the display interface;
assigning a second natural language identity code to a second natural language which the second string belongs to; and
recording the second natural language identity code and the second string in the mapping table.

6. A method for displaying a display interface when an expandable language install pack is being executed, comprising:
(a) executing the expandable language install pack to generate a mapping table and an intermediate install pack, and the mapping table comprising:
a first string; and
a string identity code corresponding to the first string;
(b) executing the intermediate install pack; and
(c) reading the first string from the mapping table according to the string identity code and displaying the first string on the display interface when the first string is going to be displayed on the display interface corresponding to the intermediate install pack.

7. The method of claim 6, wherein the mapping table is an external file with respect to the intermediate install pack.

8. The method of claim 6, wherein the mapping table further comprises:
a first natural language identity code corresponding to a first natural language which the first string belongs to; and
step (c) further comprising: executing the intermediate install pack to read the first string from the mapping table according to the string identity code and the first natural language identity code if the first natural language identity code is detected and the first string is going to be displayed.

9. The method of claim 8, wherein the mapping table further comprises:
a second string corresponding to the string identity code;
a second natural language identity code corresponding to a second natural language which the second string belongs to; and
the method further comprising:
(d) executing the intermediate install pack to read the second string from the mapping table according to the string identity code and the second natural language identity code and displaying the second string on the display interface corresponding to the intermediate install pack if the second natural language identity code is detected and the second string is going to be displayed on the display interface.

10. A system for developing an expandable language install pack, comprising:
a mapping table, comprising:
a first string; and
a string identity code corresponding to the first string; and
an install pack developer for generating an intermediate install pack without utilizing the mapping table, and utilizing the mapping table and the intermediate install pack to generate the expandable language install pack;
wherein the intermediate install pack corresponds to a display interface comprising the first string.

11. The system of claim 10, wherein the mapping table is an external file with respect to the install pack developer.

12. The system of claim 10, wherein the mapping table is an external file with respect to the intermediate install pack.

13. The system of claim 10, wherein the mapping table further comprises a first natural language identity code corresponding to a first natural language which the first string belongs to.

14. The system of claim 13, wherein the display interface further comprises a second string, and the mapping table further comprises:
the second string corresponding to the string identity code;
a second natural language identity code corresponding to a second natural language which the second string belongs to.
